(19) United States
(12) Patent Application Publication
(10) Pub. No.: US 2024/0256343 A1
(43) Pub. Date: Aug. 1, 2024

(54) COMPUTER-BASED SYSTEMS CONFIGURED FOR AUTOMATED GENERATION OF ELECTRONIC NOTIFICATIONS RELATED TO ELECTRONIC RESOURCE MANAGEMENT AND METHODS OF USE THEREOF

(71) Applicant: Capital One Services, LLC, McLean, VA (US)

(72) Inventors: Joseph Redling-Pace, Little Ferry, NJ (US); Mamadou Sylla, New York, NY (US); Mary Kaminski, Brooklyn, NY (US)

(21) Appl. No.: 18/162,334

(22) Filed: Jan. 31, 2023

(51) Int. Cl. G06F 9/50

(52) U.S. Cl. CPC G06F 9/5027

(57) ABSTRACT

A method receiving an indication of a creation of at least one data stack of a plurality of data stacks within a cloud computing environment; generating at least one creator-specific resource-specific tag, identifying at least: an identity of the creator and a start time when the at least one resource has been associated with the at least one data stack; associating the at least one creator-specific resource-specific tag with the at least one resource; continuously and automatically executing a lambda algorithm to determine each utilization duration metric of each resource of each data stack of the plurality of data stacks; dynamically determining the plurality of data stacks to retrieve metadata associated with the identity of the creator associated with the at least one data stack; and automatically generating a notification associated with the at least one data stack at a predetermined period of time.

### FIELD OF TECHNOLOGY

The present disclosure generally relates to computer-based platforms and systems configured for automated generation of electronic notifications related to electronic resource management and methods of use thereof.

### BACKGROUND OF TECHNOLOGY

Typically, an entity that creates an electronic record associated with at least one user may have to determine a duration since the creation of such electronic record and generate notifications to transmit to at least one electronic computing device of the at least one user.

### SUMMARY OF DESCRIBED SUBJECT MATTER

In some embodiments, the present disclosure provides an exemplary technically improved computer-based method that includes at least the following steps: receiving, by at least one processor, an indication of a creation of at least one data stack of a plurality of data stacks within a cloud computing environment, wherein the at least one data stack comprises at least one electronic resource being utilized by a creator of the at least one data stack to performed at least one activity within the cloud computing environment; generating, by the at least one processor, at least one creator-specific resource-specific tag, based on a plurality of indicative markers, identifying at least: an identity of the creator and a start time when the at least one resource has been associated with the at least one data stack; associating, by the at least one processor, the at least one creator-specific resource-specific tag with the at least one resource; continuously and automatically executing, by the at least one processor, a lambda algorithm to determine each utilization duration metric of each resource of each data stack of the plurality of data stacks based on each particular plurality of indicative markers of each particular creator-specific resource-specific tag; dynamically determining, by the at least one processor, based on each utilization duration metric of each resource of each data stack of the plurality of data stacks, the plurality of data stacks to retrieve metadata associated with the identity of the creator associated with the at least one data stack based on the durations of each data stack within the plurality of data stacks, wherein the metadata is contact information associated with the identity of the user; and automatically generating, by the at least one processor, utilizing a lambda algorithm, a notification associated with the at least one data stack at a predetermined period of time based on the duration of the at least one data stack, wherein the lambda algorithm is a cloud watch rule engine.

In some embodiments, the present disclosure provides an exemplary technically improved computer-based system that includes at least the following components of: at least one processor configured to execute software instructions that cause the at least one processor to perform steps to: receive, by the at least one processor, an indication of a creation of at least one data stack of a plurality of data stacks within a cloud computing environment, wherein the at least one data stack comprises at least one electronic resource being utilized by a creator of the at least one data stack to performed at least one activity within the cloud computing environment; generate, by the at least one processor, at least one creator-specific resource-specific tag, based on a plurality of indicative markers, identifying at least: an identity of the creator and a start time when the at least one resource has been associated with the at least one data stack; associate, by the at least one processor, the at least one creator-specific resource-specific tag with the at least one resource; continuously and automatically execute, by the at least one processor, a lambda algorithm to determine each utilization duration metric of each resource of each data stack of the plurality of data stacks based on each particular plurality of indicative markers of each particular creator-specific resource-specific tag; dynamically determine, by the at least one processor, based on each utilization duration metric of each resource of each data stack of the plurality of data stacks, the plurality of data stacks to retrieve metadata associated with the identity of the creator associated with the at least one data stack based on the durations of each data stack within the plurality of data stacks, wherein the metadata is contact information associated with the identity of the user; and automatically generate, by the at least one processor, utilizing a lambda algorithm, a notification associated with the at least one data stack at a predetermined period of time based on the duration of the at least one data stack, wherein the lambda algorithm is a cloud watch rule engine.

### BRIEF DESCRIPTION OF DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a block diagram of an exemplary computer-based system and platform for automatically generating a notification associated with at least one data stack at a predetermined period of time based on a duration of the at least one data stack, in accordance with one or more embodiments of the present disclosure;

FIG. 2 is a flowchart illustrating operational steps for automatically generating a notification associated with at least one data stack at a predetermined period of time, in accordance with one or more embodiments of the present disclosure;

FIG. 3 depicts a block diagram of an exemplary computer-based system/platform in accordance with one or more embodiments of the present disclosure.

FIG. 4 depicts a block diagram of another exemplary computer-based system/platform in accordance with one or more embodiments of the present disclosure.

FIGS. 5 and 6 are diagrams illustrating implementations of cloud computing architecture/aspects with respect to which the disclosed technology may be specifically configured to operate, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, daily, several days, weekly, monthly, etc.

As used herein, the term “runtime” corresponds to any behavior that is dynamically determined during an execution of a software application or at least a portion of software application.

Embodiments of the present disclosure recognize a technological computer-centered problem associated with determination of a date of creation of an electronic record (e.g., electronic account record) associated with at least one user and generation of notifications associated with the date of creation of the electronic record (e.g., electronic account record) of the at least one user. This technical problem is exacerbated in an indication of a creation of at least one data stack of a plurality of data stacks within a cloud computing environment, where each data stack may be an electronic resource. In some instances, the determination of the at least one data stack and the generation of notifications associated with the at least one data stack is electronic resource inefficient and reduces a number of notifications associated with the plurality of data stacks associated with the electronic system that may generate within a period of time. Embodiments of the present disclosure detail a computer-centric technological solution that may automatically execute a lambda algorithm to determine a plurality of duration metric associated with a plurality of data stacks, retrieves metadata associated with the identity of the creator associated with at least one data stack, and automatically generates a notification associated with the at least one data stack at a predetermined period of time using a lambda algorithm. In some embodiments, a practical solution may require instructing the cloud computing environment to delete that at least one data stack based on a lack of performed activity within the predetermined period of time.

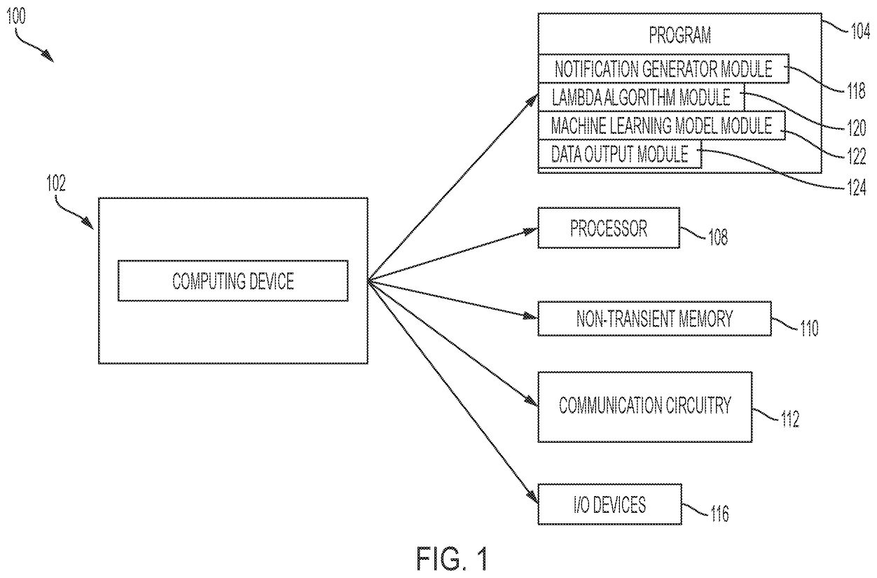

FIG. 1 depicts a block diagram of an exemplary computer-based system and platform for automatically generating a notification associated with at least one data stack at a predetermined period of time based on a duration of the at least one data stack, in accordance with one or more embodiments of the present disclosure.

In some embodiments, a computing system 100 may include a computing device 102 associated with a user and an illustrative program engine 104. In some embodiments, the program 104 may be stored on the computing device 102. In some embodiments, the program 104 may reside on a server computing device 106 (not shown). In some embodiments, the computing device 102 may include a processor 108, a non-transient memory 110, a communication circuitry 112 for communicating over a communication network 114 (not shown), and input and/or output (I/O) devices 116 such as a keyboard, mouse, a touchscreen, and/or a display, for example. In some embodiments, the computing device 102 may refer to a cloud computing environment.

In some embodiments, the illustrative program engine 104 may be configured to instruct the processor 108 to execute one or more software modules such as a notification generator module 118, a lambda algorithm module 120, a machine learning model module 122, and a data output module 124.

In some embodiments, an exemplary notification generator module 118, of the present disclosure, utilizes at least one machine learning algorithm described herein, to continuously and automatically execute a lambda algorithm module 120 that determines a duration metric associated with the creation of at least one data stack and automatically generate a notification associated with the at least one data stack based on the determined duration metric using the lambda algorithm module 120. Typically, execution of the lambda algorithm module 120 to determine the duration metric associated with the creation of the at least one data stack and generation of notification associated with the determined duration metric that may require an input from a different user. In some embodiments, the exemplary notification generator 118 may receive an indication of a creation of at least one data stack of a plurality of data stacks within a cloud computing environment (not shown). In some embodiments, the at least one data stack may refer to at least one electronic resource. In some embodiments, the at least one data stack may refer to a plurality of profile templates associated with the creator. In some embodiments, the exemplary notification generator 118 may receive the indication of the creation of the at least one data stack by identifying the at least one electronic resource being utilized by a creation of the at least one data stack to perform at least one activity within the cloud computing environment. In some embodiments, the exemplary notification generator 118 may receive an indication of the creation of a user account associated with the creator.

In some embodiments, the exemplary notification generator 118 may generate at least one creator tag based on a plurality of indicative markers. In some embodiments, the at least one creator tag may refer to a creator-specific resource-specific tag based on the plurality of indicative markers. In some embodiments, the exemplary notification generator 118 may generate the at least one creator-specific resource specific tag to identify an identity of the creation and a start time when the at least one electronic resource has been associated with the at least one data stack. In some embodiments, the creator-specific resource-specific tag may refer to a location of the creator, the identity of the creator, and an origin of creation associated with the plurality of data stacks. In some embodiments, the plurality of indicative markers may refer to a location of the creator marker, the identity of the creator marker, the start time when at least one resource has been associated with the at least one data stack marker, and a performed activity tracking marker associated with the at least one resource. In some embodiments, the exemplary notification generator 118 may associate the at least one creator-specific resource-specific tag with the at least one electronic resource associated with the at least one data stack of the plurality of data stacks.

In some embodiments, the exemplary notification generator 118 may execute the lambda algorithm module 120 to determine a utilization of at least one duration metric of each electronic resource of data stack based on each particular plurality of indicative markers of each particular creator-specific resource-specific tag. In some embodiments, the exemplary notification generator 118 may continuously and automatically execute the lambda algorithm module 120 to determine a utilization of at least one duration metric of each electronic resource of data stack based on each particular plurality of indicative markers of each particular creator-specific resource-specific tag.

In some embodiments, the exemplary notification generator 118 may dynamically determine the plurality of data stacks to receive metadata associated with the identity of the creator associated with the at least one data stack. In some embodiments, the exemplary notification generator 118 may determine the plurality of data stacks to receive the metadata based on the durations of each data stack within the plurality of data stacks. In some embodiments, the metadata may refer to contact information associated with the identity of the user. In some embodiments, the exemplary notification generator 118 may automatically generate a notification associated with the at least one data stack at a predetermined period of time based on the duration of the at least one data stack. In some embodiments, the predetermined period of time may refer to every day or every week. In some embodiments, the exemplary notification generator 118 may instruct the computing device 102 to delete the at least one data stack based on a lack of performed activity within the predetermined period of time.

In some embodiments, the lambda algorithm module 120 may determine a plurality of duration metrics of each resource of each data stack of the plurality of data stacks. In some embodiments, the lambda algorithm module 120 may determine the plurality of duration metrics based on each particular plurality of indicative marker if the plurality of indicative markers associated with each creator-specific resource-specific tag. In some embodiments, the lambda algorithm module 120 may include a cloud watch rule engine.

Embodiments of the present disclosure herein describe systems for utilizing the machine learning model module 122 for generating at least one creator-specific resource specific tag based on the plurality of indicative markers. In some embodiments, the machine learning model module 122 may generate the at least one creator-specific resource-specific tag to identify the identity of the creator and a start time when the at least one electronic resource has been associated with the at least one data stack. In some embodiments, the machine learning model module 122 may identify a location of the creator of the at least one data stack and at least one performed activity tracking marker associated with the at least one resource. In some embodiments, the machine learning model module 122 may dynamically determine the plurality of data stacks to retrieve metadata based on each utilization duration metric of each resource of each data stack of the plurality of data stacks. In some embodiments, the machine learning model module 122 may generate instructions to transmit to the computing device 102 to delete the at least one data stack in the plurality of data stacks based on the lack of performed activity within the predetermined period of time. In some embodiments, output of the machine learning model module 122 may be the retrieved metadata determined for each data stack in the plurality of data stacks. In some embodiments, the output of the machine learning model module 122 may be an automatically generated notification associated with the at least one data stack based on the utilization of the lambda algorithm module 124.

In some embodiments, the data output module 124 may dynamically determine the plurality of plurality of data stacks to retrieve the metadata associated with the at least one data stack based on the output of the machine learning model module 122, where the data output module 124 may utilize the lambda algorithm module 120 to automatically generate the notification associated with the at least one data stack at the predetermined period of time based on output of the machine learning model module 122. In some embodiments, the data output module 124 may display the generated instructions to delete the at least one data stack in the plurality of data stacks based on the performed activity within the predetermined period of time.

In some embodiments, the program 104 may receive the indication of the creation of the at least one data stack of the plurality of data stacks within the computing device 102. In some embodiments, the program 104 may generate the at least one creator-specific resource-specific tag based on the plurality of indicative markers to identify an identity of the creator and a start time when the at least one electronic resource has been associated with the at least one data stack. In some embodiments, the program 104 may associate the at least one creator-specific resource-specific tag with the at least one electronic resource. In some embodiments, the program 104 may continuously and automatically execute the lambda algorithm module 120 to determine each utilization duration metric of each resource of each data stack of the plurality of data stacks based on each particular plurality of indicative markers of each particular creator-specific resource-specific tag. In some embodiments, the program 104 may dynamically determine the plurality of data stacks to retrieve metadata associated with the identity of the creation associated with the at least one data stack based on the durations of each data stack within the plurality of data stacks. In some embodiments, the program 104 may automatically generate the notification associated with the at least one data stack at the predetermined period of time based on the duration of the at least one data stack.

In some embodiments, the non-transient memory 110 may store the automatically generated notification associated with the at least one data stack. In some embodiments, the non-transient memory 110 may store the output of the machine learning model module 122. In some embodiments, the non-transient memory 110 may store the output of the data output module 124.

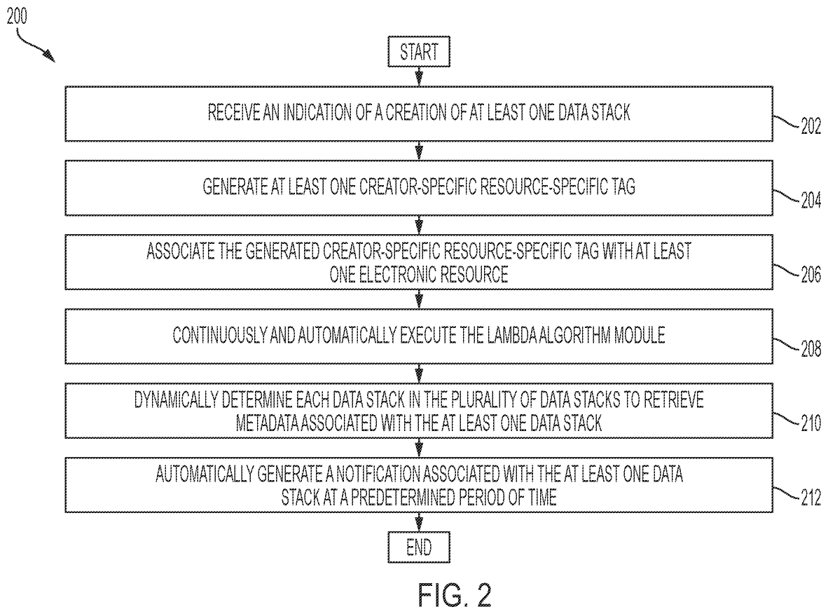

FIG. 2 is a flowchart 200 illustrating operational steps for automatically generating a notification associated with at least one data stack at a predetermined period of time, in accordance with one or more embodiments of the present disclosure.

In step 202, the illustrative program engine 104 within the computing device 102 may be programmed to receive an indication of a creation of at least one data stack of a plurality of data stacks within a clouding computing environment. In some embodiments, the at least one data stack includes at least one electronic resource being utilized by a creator of the at least one data stack to perform at least one activity within the computing device 102.

In step 204, the illustrative program engine 104 may be programmed to generate at least one user tag. In some embodiments, the exemplary notification generator module 118 may be programmed to generate at least one creator-specific resource-specific tag. In some embodiments, the generated creator-specific resource-specific tag may be based on a plurality of indicative markers. In some embodiments, the plurality of indicative markers associated with the generated creator-specific resource-specific tag may identify an identity of the creator and a start time when that least one electronic resource has been associated with the at least one data stack.

In step 206, the illustrative program engine 104 may be programmed to associate the generated creator-specific resource-specific tag with the at least one electronic resource. In some embodiments, the exemplary notification generator module 118 may be programmed to generate the creator-specific resource-specific tag.

In step 208, the illustrative program engine 104 may be programmed to execute the lambda algorithm module 120. In some embodiments, the exemplary notification generator module 118 may be programmed to continuously and automatically execute the lambda algorithm module 120. In some embodiments, the continuous and automatic execution of the lambda algorithm module 120 may determine each utilization duration metric of a plurality of utilization duration metrics of each electronic resource associated with each data stack in the plurality of data stacks. In some embodiments, the continuous and automatic execution of the lambda algorithm module 120 may be based on each particular plurality of indicative markers associated with each particular creator-specific resource-specific tag.

In step 210, the illustrative program engine 104 may be programmed to determine each data stack in the plurality of data stacks to retrieve metadata associated with the at least one data stack. In some embodiments, the exemplary notification generator module 118 may be programmed to dynamically determine each data stack in the plurality of data stacks to retrieve metadata associated with the identity of the creator associated with the at least one data stack. In some embodiments, the retrieved metadata may be based on the durations of each data stack within the plurality of data stacks, where the metadata may refer to contact information associated with the identity of the user.

In step 212, the illustrative program engine 104 may be programmed to automatically generate a notification associated with the at least one data stack at a predetermined period of time. In some embodiments, the exemplary notification generator module 118 may be programmed to automatically generate the notification utilizing the lambda algorithm module 120 at the predetermined period of time based on the duration of the at least on data stack. In some embodiments, the exemplary notification generator module 118 may be programmed to automatically generate the notification associated with the at least one data stack at the predetermined period of time using a cloud watch rule engine.

Table 1 provides exemplary computer instructions of an exemplary version of the lambda algorithm of the lambda algorithm module 120, demonstrating, for example without limitation, an illustrative way to achieve cost saving of electronic resources and notification generation.

```
TABLE 1
import json
import boto3
import datetime
import logging
logger = logging.getLogger( )
#logger.setLevel(logging.DEBUG)
client = boto3.client(‘cloudformation’,region_name=‘us-east-1’)
sns_client = boto3.client(‘sns’,region_name=‘us-east-1’)
def lambda_handler(event, context):
  stack_list = get_apollo_stack_list( )
  time_filtered_stacks, contact_emails =
  filter_apollo_stacks(stack_list)
  send_message(time_filtered_stacks, contact_emails)
  return {
    ‘statusCode’: 200,
    ‘body’: json.dumps(“done”)
  }
def get_apollo_stack_list( ):
  response = client.describe_stacks( )
  stack_list = [ ]
  for stack in response[‘Stacks’]:
    if stack[‘StackStatus’] == ‘CREATE_COMPLETE’:
      for tag in stack[‘Tags’]:
        if tag[‘Key’] == ‘ASV’:
          if tag[‘Value’] == ‘ASVBUSINESSBUREAU’:
            stack_list.append(stack[‘StackId’])
          break
  print(‘Printing list of all Apollo stacks IDs:’)
  print(stack_list)
  return stack_list
def filter_apollo_stacks(stackIds):
  expired_stacks = [ ]
  contact_emails = [ ]
  contact = “”
  today = datetime.date.today( )
  for stackId in stackIds:
    stack = client.describe_stacks(StackName=stackId)
    stack_age = abs((today −
    stack[‘Stacks’][0][‘CreationTime’].date( )).days)
    print(‘Stack id = ’ + str(stackId) + ‘ age = ’ + str(stack_age))
    if stack_age >= 7:
      expired_stacks.append(stackId)
      for tag in stack[‘Stacks’][0][‘Tags’]:
        if tag[‘Key’] == ‘CreatorContact’:
          contact = tag[‘Value’]
          break
        elif tag[‘Key’] == ‘OwnerContact’:
          contact = tag[‘Value’]
      contact_emails.append(contact)
  print(“Printing expired stacks”)
  print(expired_stacks)
  print(“Printing contact emails”)
  print(contact_emails)
  return expired_stacks, contact_emails
def send_message(time_filtered_stacks, contact_emails):
  message=“ARNs of CloudFormation Stacks created
  more than 7 days ago: \n”
  for stack, email in zip(time_filtered_stacks, contact_emails):
    message += “Contact Email: ” + str(email) + “ \tCFT
    ARN: ” + str(stack) + “\n”
  print(message)
  response = sns_client.publish(
    TopicArn=‘arn:aws:sns:us-east-1:<SPECIFIC TOPIC ID>:NotifyMe’,
    Message=message,
    Subject=“NOTICE: Old CloudFormationStack ARNs”
    )
  print(str(response))
```

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; knowledge corpus; stored audio recordings; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. In some embodiments, the server may store transactions and dynamically trained machine learning models. Cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a social media post, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD™, NetBSD™, OpenBSD™; (2) Linux™; (3) Microsoft Windows™; (4) OS X (MacOS)™; (5) MacOS 11™; (6) Solaris™; (7) Android™; (8) iOS™; (9) Embedded Linux™; (10) Tizen™; (11) WebOS™; (12) IBM i™; (13) IBM AIX™; (14) Binary Runtime Environment for Wireless (BREW)™; (15) Cocoa (API)™; (16) Cocoa Touch™; (17) Java Platforms™; (18) JavaFX™; (19) JavaFX Mobile;™ (20) Microsoft DirectX™; (21) .NET Framework™; (22) Silverlight™; (23) Open Web Platform™; (24) Oracle Database™; (25) Qt™; (26) Eclipse Rich Client Platform™; (27) SAP NetWeaver™; (28) Smartface™; and/or (29) Windows Runtime™.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device. In at least one embodiment, the exemplary ASR system of the present disclosure, utilizing at least one machine-learning model described herein, may be referred to as exemplary software.

In some embodiments, exemplary inventive computer-based systems/platforms, exemplary inventive computer-based devices, and/or exemplary inventive computer-based components of the present disclosure may be configured to handle numerous concurrent transactions/users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, the exemplary ASR system of the present disclosure, utilizing at least one machine-learning model described herein, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™ Pager, Smartphone, or any other reasonable mobile electronic device.

In some embodiments, the exemplary inventive computer-based systems/platforms, the exemplary inventive computer-based devices, and/or the exemplary inventive computer-based components of the present disclosure may be configured to securely store and/or transmit data (e.g., tokenized PAN numbers, etc.) by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH),WHIRLPOOL, RNGs).

The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

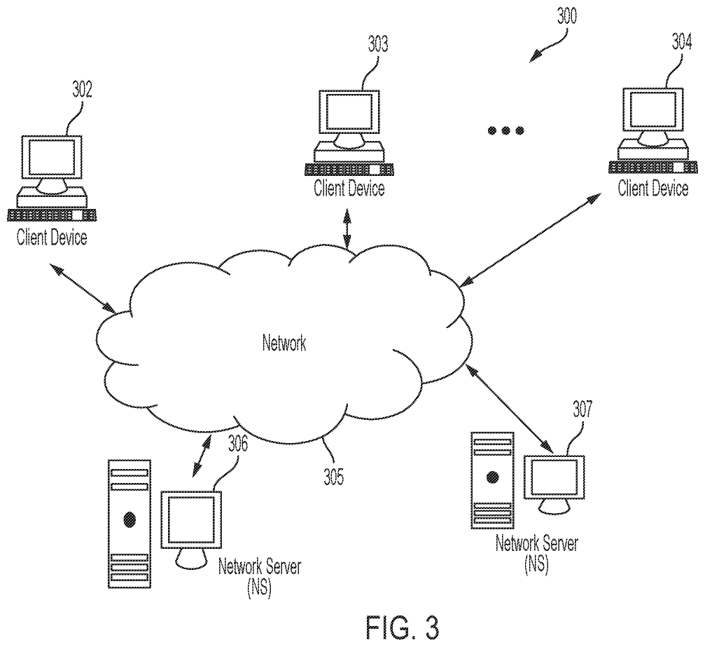

FIG. 3 depicts a block diagram of an exemplary computer-based system/platform 300 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform 300 may be configured to manage a large number of members and/or concurrent transactions, as detailed herein. In some embodiments, the exemplary computer-based system/platform 300 may be based on a scalable computer and/or network architecture that incorporates varies strategies for assessing the data, caching, searching, and/or database connection pooling. An example of the scalable architecture is an architecture that is capable of operating multiple servers. In some embodiments, the exemplary inventive computing devices and/or the exemplary inventive computing components of the exemplary computer-based system/platform 300 may be configured to manage the exemplary ASR system of the present disclosure, utilizing at least one machine-learning model described herein.

In some embodiments, referring to FIG. 3, members 302-304 (e.g., clients) of the exemplary computer-based system/platform 300 may include virtually any computing device capable of receiving and sending a message over a network (e.g., cloud network), such as network 305, to and from another computing device, such as servers 306 and 307, each other, and the like. In some embodiments, the member devices 302-304 may be personal computers, multiprocessor systems, microprocessor-based or programmable consumer electronics, network PCs, and the like. In some embodiments, one or more member devices within member devices 302-304 may include computing devices that connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 302-304 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 302-304 may include may run one or more applications, such as Internet browsers, mobile applications, voice calls, video games, videoconferencing, and email, among others. In some embodiments, one or more member devices within member devices 402-404 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 402-404 may be specifically programmed by either Java, .Net, QT, C, C++ and/or other suitable programming language. In some embodiments, one or more member devices within member devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 305 may provide network access, data transport and/or other services to any computing device coupled to it. In some embodiments, the exemplary network 305 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 305 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 305 may include and implement, as an alternative or in conjunction with one or more of the above, a WiMAX architecture defined by the WiMAX forum. In some embodiments and, optionally, in combination of any embodiment described above or below, the exemplary network 305 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 305 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 405 may also include mass storage, such as network attached storage (NAS), a storage area network (SAN), a content delivery network (CDN) or other forms of computer or machine readable media.

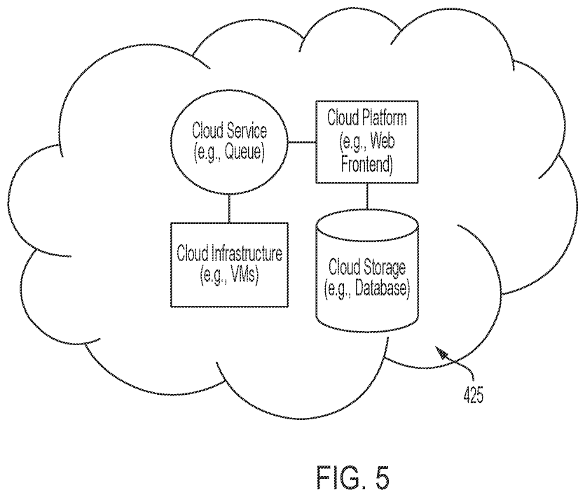

In some embodiments, the exemplary server 306 or the exemplary server 307 may be a web server (or a series of servers) running a network operating system, examples of which may include but are not limited to Microsoft Windows Server, Novell NetWare, or Linux. In some embodiments, the exemplary server 306 or the exemplary server 307 may be used for and/or provide cloud and/or network computing. Although not shown in FIG. 5, in some embodiments, the exemplary server 306 or the exemplary server 307 may have connections to external systems like email, SMS messaging, text messaging, ad content providers, etc. Any of the features of the exemplary server 306 may be also implemented in the exemplary server 307 and vice versa.

In some embodiments, one or more of the exemplary servers 306 and 307 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 301-304.

In some embodiments and, optionally, in combination of any embodiment described above or below, for example, one or more exemplary computing member devices 302-304, the exemplary server 306, and/or the exemplary server 307 may include a specifically programmed software module that may be configured to send, process, and receive information (e.g., transactions, VCNs, etc.) using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

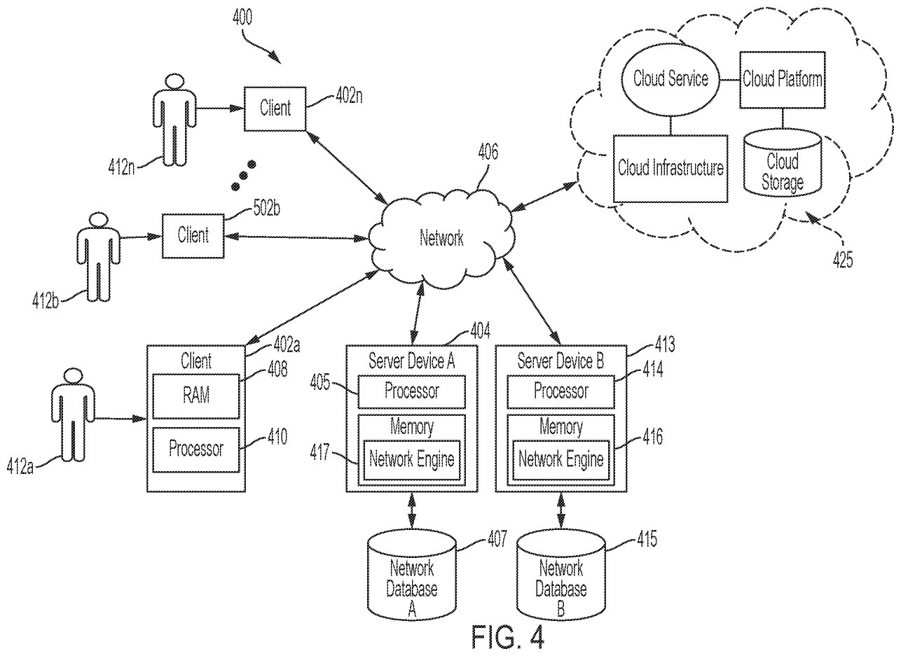

FIG. 4 depicts a block diagram of another exemplary computer-based system/platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 402a, 402b thru 402n shown each at least includes a computer-readable medium, such as a random-access memory (RAM) 408 coupled to a processor 410 or FLASH memory. In some embodiments, the processor 410 may execute computer-executable program instructions stored in memory 408. In some embodiments, the processor 410 may include a microprocessor, an ASIC, and/or a state machine. In some embodiments, the processor 410 may include, or may be in communication with, media, for example computer-readable media, which stores instructions that, when executed by the processor 410, may cause the processor 410 to perform one or more steps described herein. In some embodiments, examples of computer-readable media may include, but are not limited to, an electronic, optical, magnetic, or other storage or transmission device capable of providing a processor, such as the processor 410 of client 402a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 402a through 402n may also comprise a number of external or internal devices such as a mouse, a CD-ROM, DVD, a physical or virtual keyboard, a display, a speaker, or other input or output devices. In some embodiments, examples of member computing devices 402a through 402n (e.g., clients) may be any type of processor-based platforms that are connected to a network 406 such as, without limitation, personal computers, digital assistants, personal digital assistants, smart phones, pagers, digital tablets, laptop computers, Internet appliances, and other processor-based devices. In some embodiments, member computing devices 402a through 402n may be specifically programmed with one or more application programs in accordance with one or more principles/methodologies detailed herein. In some embodiments, member computing devices 402a through 402n may operate on any operating system capable of supporting a browser or browser-enabled application, such as Microsoft™ Windows™, and/or Linux. In some embodiments, member computing devices 402a through 402n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 402a through 402n, users, 412a through 412n, may communicate over the exemplary network 506 with each other and/or with other systems and/or devices coupled to the network 406. As shown in FIG. 4, exemplary server devices 404 and 413 may be also coupled to the network 406. Exemplary server device 404 may include a processor 405 coupled to a memory that stores a network engine 417. Exemplary server device 413 may include a processor 414 coupled to a memory 416 that stores a network engine. In some embodiments, one or more member computing devices 402a through 402n may be mobile clients. As shown in FIG. 4, the network 406 may be coupled to a cloud computing/architecture(s) 425. The cloud computing/architecture(s) 425 may include a cloud service coupled to a cloud infrastructure and a cloud platform, where the cloud platform may be coupled to a cloud storage.

In some embodiments, at least one database of exemplary databases 407 and 415 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

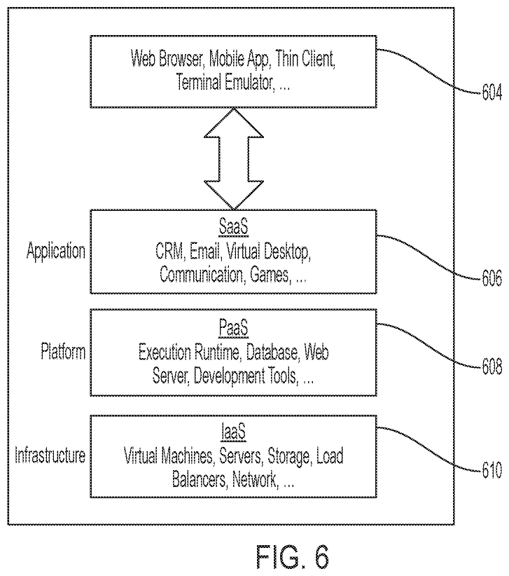

FIG. 5 and FIG. 6 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate. FIG. 5 illustrates an expanded view of the cloud computing/architecture(s) 425 found in FIG. 4. FIG. 6. illustrates the exemplary inventive computer-based components of the present disclosure may be specifically configured to operate in the cloud computing/architecture 425 as a source database 604, where the source database 604 may be a web browser. a mobile application, a thin client, and a terminal emulator. In FIG. 6, the exemplary inventive computer-based systems/platforms, the exemplary inventive computer-based devices, and/or the exemplary inventive computer-based components of the present disclosure may be specifically configured to operate in an cloud computing/architecture such as, but not limiting to: infrastructure a service (IaaS) 610, platform as a service (PaaS) 608, and/or software as a service (SaaS) 606.

In some embodiments, the exemplary inventive computer-based systems/platforms, the exemplary inventive computer-based devices, and/or the exemplary inventive computer-based components of the present disclosure may be configured to utilize one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, an artificial recurrent neural network model, a long short-term memory (“LSTM”) model, and a distributed long short-term memory (“DLSTM”) model, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
i) Define Neural Network architecture/model,
ii) Transfer the input data to the exemplary neural network model,
iii) Train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

At least some aspects of the present disclosure will now be described with reference to the following numbered clauses.

Clause 1. A method may include:
receiving, by at least one processor, an indication of a creation of at least one data stack of a plurality of data stacks within a cloud computing environment, where the at least one data stack includes at least one electronic resource being utilized by a creator of the at least one data stack to performed at least one activity within the cloud computing environment;
generating, by the at least one processor, at least one creator-specific resource-specific tag, based on a plurality of indicative markers, identifying at least:
   an identity of the creator and
   a start time when the at least one resource has been associated with the at least one data stack;
associating, by the at least one processor, the at least one creator-specific resource-specific tag with the at least one resource;
continuously and automatically executing, by the at least one processor, a lambda algorithm to determine each utilization duration metric of each resource of each data stack of the plurality of data stacks based on each particular plurality of indicative markers of each particular creator-specific resource-specific tag;
dynamically determining, by the at least one processor, based on each utilization duration metric of each resource of each data stack of the plurality of data stacks, the plurality of data stacks to retrieve metadata associated with the identity of the creator associated with the at least one data stack based on the durations of each data stack within the plurality of data stacks, where the metadata is contact information associated with the identity of the user; and
automatically generating, by the at least one processor, utilizing a lambda algorithm, a notification associated with the at least one data stack at a predetermined period of time based on the duration of the at least one data stack, where the lambda algorithm is a cloud watch rule engine.

Clause 2. The method according to clause 1, where the indication of the creation of the at least one data stack of the plurality of data stacks includes an indication of a creation of a user account associated with the creator.

Clause 3. The method according to clause 1 or 2, where the at least one data stack of the plurality of data stacks includes a plurality of profile templates associated with the creator.

Clause 4. The method according to clause 1, 2, or 3, where generating the at least one creator-specific resource-specific tag includes a location of the creator, the identity of the creator, and an origin of creation associated with the plurality of data stacks.

Clause 5. The method according to clause 1, 2, 3, or 4, where the plurality of indicative markers includes:
a location of the creator marker,
the identity of the creator marker.
the start time when the at least one resource has been associated with the at least one data stack marker; and
performed activity tracking marker associated with the at least one resource.

Clause 6. The method according to clause 1, 2, 3, 4, or 5, where automatically generating the notification associated with the at least one data stack includes generating a notification alerting the creator of a lack of monitored activity associated with the at least one data stack.

Clause 7. The method according to clause 1, 2, 3, 4, 5, or 6, further instructing, by the at least one processor, based on a generation of the notification associated the at least one data stack, the cloud computing environment to delete the at least one data stack in the plurality of the data stacks based on a lack of performed activity within the predetermined period of time.

Clause 8. A method includes:
receiving, by at least one processor, an indication of a creation of at least one data stack of a plurality of data stacks within a cloud computing environment, where the at least one data stack includes at least one electronic resource being utilized by a creator of the at least one data stack to performed at least one activity within the cloud computing environment;
generating, by the at least one processor, at least one creator-specific resource-specific tag, based on, at least:
   an identity of the creator,
   a location of the creator, and
   a start time when the at least one resource has been associated with the at least one data stack;
associating, by the at least one processor, the at least one creator-specific resource-specific tag with the at least one resource;
continuously and automatically executing, by the at least one processor, a lambda algorithm to determine each utilization duration metric of each resource of each data stack of the plurality of data stacks based on each start time when the at least one resource has been associated with the at least one data stack of each particular creator-specific resource-specific tag;
dynamically determining, by the at least one processor, based on each utilization duration metric of each resource of each data stack of the plurality of data stacks, the plurality of data stacks to retrieve metadata associated with the identity of the creator associated with the at least one data stack based on the durations of each data stack within the plurality of data stacks, where the metadata is contact information associated with the identity of the user;
automatically generating, by the at least one processor, utilizing a cloud watch rule engine, a notification associated with the at least one data stack at a predetermined period of time based on the duration of the at least one data stack; and
instructing, by the at least one processor, based on a generation of the notification associated the at least one data stack, the cloud computing environment to delete the at least one data stack in the plurality of the data stacks based on a lack of performed activity within the predetermined period of time.

Clause 9. The method according to clause 8, where the indication of the creation of the at least one data stack of the plurality of data stacks includes an indication of a creation of a user account associated with the creator.

Clause 10. The method according to clause 8 or 9, where the at least one data stack of the plurality of data stacks includes a plurality of profile templates associated with the creator.

Clause 11. The method according to clause 8, 9, or 10, where generating the at least one creator-specific resource-specific tag includes generating the at least one creator specific resource specific tag based on a plurality of indicative markers.

Clause 12. The method according to clause 8, 9, 10, or 11, where the plurality of indicative markers includes:
a location of the creator marker,
the identity of the creator marker.
the start time when the at least one resource has been associated with the at least one data stack marker; and
performed activity tracking marker associated with the at least one resource.

Clause 13. The method according to clause 8, 9, 10, 11, or 12, where automatically generating the notification associated with the at least one data stack includes generating a notification alerting the creator of a lack of monitored activity associated with the at least one data stack.

Clause 14. A system may include:
at least one processor configured to execute software instructions that cause the at least one processor to perform steps to:
   program instructions to receive, by the at least one processor, an indication of a creation of at least one data stack of a plurality of data stacks within a cloud computing environment, where the at least one data stack includes at least one electronic resource being utilized by a creator of the at least one data stack to performed at least one activity within the cloud computing environment;
   program instructions to generate, by the at least one processor, at least one creator-specific resource-specific tag, based on a plurality of indicative markers, identifying at least:
      an identity of the creator and
      a start time when the at least one resource has been associated with the at least one data stack;
   program instructions to associate, by the at least one processor, the at least one creator-specific resource-specific tag with the at least one resource;
   program instructions to continuously and automatically execute, by the at least one processor, a lambda algorithm to determine each utilization duration metric of each resource of each data stack of the plurality of data stacks based on each particular plurality of indicative markers of each particular creator-specific resource-specific tag;
   program instructions to dynamically determine, by the at least one processor, based on each utilization duration metric of each resource of each data stack of the plurality of data stacks, the plurality of data stacks to retrieve metadata associated with the identity of the creator associated with the at least one data stack based on the durations of each data stack within the plurality of data stacks, where the metadata is contact information associated with the identity of the user; and
   program instructions to automatically generate, by the at least one processor, utilizing a lambda algorithm, a notification associated with the at least one data stack at a predetermined period of time based on the duration of the at least one data stack, wherein the lambda algorithm is a cloud watch rule engine.

Clause 15. The system according to clause 14, where the indication of the creation of the at least one data stack of the plurality of data stacks includes an indication of a creation of a user account associated with the creator.

Clause 16. The system according to clause 14 or 15, where the at least one data stack of the plurality of data stacks includes a plurality of profile templates associated with the creator.

Clause 17. The system according to clause 14, 15, or 16, where the program instructions to generate the at least one creator-specific resource-specific tag includes a location of the creator, the identity of the creator, and an origin of creation associated with the plurality of data stacks.

Clause 18. The system according to clause 14, 15, 16, or 17, wherein the plurality of indicative markers includes:
a location of the creator marker,
the identity of the creator marker.
the start time when the at least one resource has been associated with the at least one data stack marker; and
performed activity tracking marker associated with the at least one resource.

Clause 19. The system according to clause 14, 15, 16, 17, or 18, where the program instructions to automatically generate the notification associated with the at least one data stack includes program instructions to generate a notification alerting the creator of a lack of monitored activity associated with the at least one data stack.

Clause 20. The system according to clause 14, 15, 16, 17, 18, or 19, the at least one processor performs program instructions to further include program instructions to instruct, by the at least one processor, based on a generation of the notification associated the at least one data stack, the cloud computing environment to delete the at least one data stack in the plurality of the data stacks based on a lack of performed activity within the predetermined period of time.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A computer-implemented method comprising:
receiving, by at least one processor, an indication of a creation of at least one data stack of a plurality of data stacks within a cloud computing environment, wherein the at least one data stack comprises at least one electronic resource being utilized by a creator of the at least one data stack to performed at least one activity within the cloud computing environment;
generating, by the at least one processor, at least one creator-specific resource-specific tag, based on a plurality of indicative markers, identifying at least:
an identity of the creator and
a start time when the at least one resource has been associated with the at least one data stack;
associating, by the at least one processor, the at least one creator-specific resource-specific tag with the at least one resource;
continuously and automatically executing, by the at least one processor, a lambda algorithm to determine each utilization duration metric of each resource of each data stack of the plurality of data stacks based on each particular plurality of indicative markers of each particular creator-specific resource-specific tag;
dynamically determining, by the at least one processor, based on each utilization duration metric of each resource of each data stack of the plurality of data stacks, the plurality of data stacks to retrieve metadata associated with the identity of the creator associated with the at least one data stack based on the durations of each data stack within the plurality of data stacks, wherein the metadata is contact information associated with the identity of the user; and
automatically generating, by the at least one processor, utilizing a lambda algorithm, a notification associated with the at least one data stack at a predetermined period of time based on the duration of the at least one data stack, wherein the lambda algorithm is a cloud watch rule engine.

2. The computer-implemented method of claim 1, wherein the indication of the creation of the at least one data stack of the plurality of data stacks comprises an indication of a creation of a user account associated with the creator.

3. The computer-implemented method of claim 1, wherein the at least one data stack of the plurality of data stacks comprises a plurality of profile templates associated with the creator.

4. The computer-implemented method of claim 1, wherein generating the at least one creator-specific resource-specific tag comprises a location of the creator, the identity of the creator, and an origin of creation associated with the plurality of data stacks.

5. The computer-implemented method of claim 1, wherein the plurality of indicative markers comprises:
a location of the creator marker,
the identity of the creator marker.
the start time when the at least one resource has been associated with the at least one data stack marker; and
performed activity tracking marker associated with the at least one resource.

6. The computer-implemented method of claim 1, wherein automatically generating the notification associated with the at least one data stack comprises generating a notification alerting the creator of a lack of monitored activity associated with the at least one data stack.

7. The computer-implemented method of claim 1, further comprising instructing, by the at least one processor, based on a generation of the notification associated the at least one data stack, the cloud computing environment to delete the at least one data stack in the plurality of the data stacks based on a lack of performed activity within the predetermined period of time.

8. A computer-implemented method comprising:
receiving, by at least one processor, an indication of a creation of at least one data stack of a plurality of data stacks within a cloud computing environment, wherein the at least one data stack comprises at least one electronic resource being utilized by a creator of the at least one data stack to performed at least one activity within the cloud computing environment;
generating, by the at least one processor, at least one creator-specific resource-specific tag, based on, at least:
an identity of the creator,
a location of the creator, and
a start time when the at least one resource has been associated with the at least one data stack;
associating, by the at least one processor, the at least one creator-specific resource-specific tag with the at least one resource;
continuously and automatically executing, by the at least one processor, a lambda algorithm to determine each utilization duration metric of each resource of each data stack of the plurality of data stacks based on each start time when the at least one resource has been associated with the at least one data stack of each particular creator-specific resource-specific tag;
dynamically determining, by the at least one processor, based on each utilization duration metric of each resource of each data stack of the plurality of data stacks, the plurality of data stacks to retrieve metadata associated with the identity of the creator associated with the at least one data stack based on the durations of each data stack within the plurality of data stacks, wherein the metadata is contact information associated with the identity of the user;
automatically generating, by the at least one processor, utilizing a cloud watch rule engine, a notification associated with the at least one data stack at a predetermined period of time based on the duration of the at least one data stack; and
instructing, by the at least one processor, based on a generation of the notification associated the at least one data stack, the cloud computing environment to delete the at least one data stack in the plurality of the data stacks based on a lack of performed activity within the predetermined period of time.

9. The computer-implemented method of claim 8, wherein the indication of the creation of the at least one data stack of the plurality of data stacks comprises an indication of a creation of a user account associated with the creator.

10. The computer-implemented method of claim 8, wherein the at least one data stack of the plurality of data stacks comprises a plurality of profile templates associated with the creator.

11. The computer-implemented method of claim 8, wherein generating the at least one creator-specific resource-specific tag comprises generating the at least one creator specific resource specific tag based on a plurality of indicative markers.

12. The computer-implemented method of claim 11, wherein the plurality of indicative markers comprises:
a location of the creator marker,
the identity of the creator marker.
the start time when the at least one resource has been associated with the at least one data stack marker; and
performed activity tracking marker associated with the at least one resource.

13. The computer-implemented method of claim 8, wherein automatically generating the notification associated with the at least one data stack comprises generating a notification alerting the creator of a lack of monitored activity associated with the at least one data stack.

14. A system comprising:
at least one processor configured to execute software instructions that cause the at least one processor to perform steps to: program instructions to receive, by the at least one processor, an indication of a creation of at least one data stack of a plurality of data stacks within a cloud computing environment, wherein the at least one data stack comprises at least one electronic resource being utilized by a creator of the at least one data stack to performed at least one activity within the cloud computing environment;
program instructions to generate, by the at least one processor, at least one creator-specific resource-specific tag, based on a plurality of indicative markers, identifying at least:
an identity of the creator and
a start time when the at least one resource has been associated with the at least one data stack;
program instructions to associate, by the at least one processor, the at least one creator-specific resource-specific tag with the at least one resource;
program instructions to continuously and automatically execute, by the at least one processor, a lambda algorithm to determine each utilization duration metric of each resource of each data stack of the plurality of data stacks based on each particular plurality of indicative markers of each particular creator-specific resource-specific tag;
program instructions to dynamically determine, by the at least one processor, based on each utilization duration metric of each resource of each data stack of the plurality of data stacks, the plurality of data stacks to retrieve metadata associated with the identity of the creator associated with the at least one data stack based on the durations of each data stack within the plurality of data stacks, wherein the metadata is contact information associated with the identity of the user; and
program instructions to automatically generate, by the at least one processor, utilizing a lambda algorithm, a notification associated with the at least one data stack at a predetermined period of time based on the duration of the at least one data stack, wherein the lambda algorithm is a cloud watch rule engine.

15. The system of claim 14, wherein the indication of the creation of the at least one data stack of the plurality of data stacks comprises an indication of a creation of a user account associated with the creator.

16. The system of claim 14, wherein the at least one data stack of the plurality of data stacks comprises a plurality of profile templates associated with the creator.

17. The system of claim 14, wherein the program instructions to generate the at least one creator-specific resource-specific tag comprise a location of the creator, the identity of the creator, and an origin of creation associated with the plurality of data stacks.

18. The system of claim 14, wherein the plurality of indicative markers comprises:
a location of the creator marker,
the identity of the creator marker.
the start time when the at least one resource has been associated with the at least one data stack marker; and
performed activity tracking marker associated with the at least one resource.

19. The system of claim 14, wherein the program instructions to automatically generate the notification associated with the at least one data stack comprise program instructions to generate a notification alerting the creator of a lack of monitored activity associated with the at least one data stack.

20. The system of claim 14, the at least one processor performs program instructions to further comprise program instructions to instruct, by the at least one processor, based on a generation of the notification associated the at least one data stack, the cloud computing environment to delete the at least one data stack in the plurality of the data stacks based on a lack of performed activity within the predetermined period of time.
